(19) United States
(12) Patent Application Publication
(10) Pub. No.: US 2011/0267067 A1
(43) Pub. Date: Nov. 3, 2011

(54) ELECTRONIC BATTERY TESTER

(76) Inventors: Kevin I. Bertness, Batavia, IL (US); Jeremy Decker, Woodridge, IL (US); Tood J. Stukenberg, Indian Head Park, IL (US)

(21) Appl. No.: 12/769,911

(22) Filed: Apr. 29, 2010

(51) Int. Cl. G01N 27/416

(52) U.S. Cl. 324/426

(57) ABSTRACT

An electronic battery tester for testing a storage battery including electrical connectors configured to couple to the storage battery. Measurement circuitry is coupled to the electrical connectors and a display is configured to display information to an operator. A manual input is configured to receive an input from a user. A microprocessor is coupled to the measurement circuitry and is configured to perform a battery test on the storage battery as a function of a battery parameter measured with the measurement circuitry. The microprocessor is configured to display characters and receive a character select input from the manual input which identifies one character of a plurality of characters displayed on the display. In another aspect, a forcing function is coupled to the battery and has first and second selectable frequencies. The microprocessor is configured to select between the first frequency and the second frequency.

### BACKGROUND OF THE INVENTION

The present invention relates to electronic battery tester for testing storage batteries.

Storage batteries, typically, lead-acid storage batteries, are used in many applications. Examples include storage batteries for use in automotive vehicles as well as stationery batteries for use in, for example, stand-by power systems. As a storage battery ages and experiences discharge and recharge cycles, the storage battery tends to degrade with time. Therefore, it is often desirable to test the storage battery to determine its usefulness.

Various types of battery test are used to test storage batteries. Simple examples of such tests include voltage measurements and load tests. Another type of test is an invasive test in which the specific gravity of the battery acid is measured. A more sophisticated type of battery test is an electronic battery test in which a dynamic parameter of the battery is measured. Such techniques were pioneered by Dr. Keith S. Champlin and Midtronics, Inc. of Willowbrook Ill. Examples of this technique is illustrated in U.S. Pat. No. 3,873,911, issued Mar. 25, 1975, to Champlin; U.S. Pat. No. 3,909,708, issued Sep. 30, 1975, to Champlin; U.S. Pat. No. 4,816,768, issued Mar. 28, 1989, to Champlin; U.S. Pat. No. 4,825,170, issued Apr. 25, 1989, to Champlin; U.S. Pat. No. 4,881,038, issued Nov. 14, 1989, to Champlin; U.S. Pat. No. 4,912,416, issued Mar. 27, 1990, to Champlin; U.S. Pat. No. 5,140,269, issued Aug. 18, 1992, to Champlin; U.S. Pat. No. 5,343,380, issued Aug. 30, 1994; U.S. Pat. No. 5,572,136, issued Nov. 5, 1996; U.S. Pat. No. 5,574,355, issued Nov. 12, 1996; U.S. Pat. No. 5,583,416, issued Dec. 10, 1996; U.S. Pat. No. 5,585,728, issued Dec. 17, 1996; U.S. Pat. No. 5,589,757, issued Dec. 31, 1996; U.S. Pat. No. 5,592,093, issued Jan. 7, 1997; U.S. Pat. No. 5,598,098, issued Jan. 28, 1997; U.S. Pat. No. 5,656,920, issued Aug. 12, 1997; U.S. Pat. No. 5,757,192, issued May 26, 1998; U.S. Pat. No. 5,821,756, issued Oct. 13, 1998; U.S. Pat. No. 5,831,435, issued Nov. 3, 1998; U.S. Pat. No. 5,871,858, issued Feb. 16, 1999; U.S. Pat. No. 5,914,605, issued Jun. 22, 1999; U.S. Pat. No. 5,945,829, issued Aug. 31, 1999; U.S. Pat. No. 6,002,238, issued Dec. 14, 1999; U.S. Pat. No. 6,037,751, issued Mar. 14, 2000; U.S. Pat. No. 6,037,777, issued Mar. 14, 2000; U.S. Pat. No. 6,051,976, issued Apr. 18, 2000; U.S. Pat. No. 6,081,098, issued Jun. 27, 2000; U.S. Pat. No. 6,091,245, issued Jul. 18, 2000; U.S. Pat. No. 6,104,167, issued Aug. 15, 2000; U.S. Pat. No. 6,137,269, issued Oct. 24, 2000; U.S. Pat. No. 6,163,156, issued Dec. 19, 2000; U.S. Pat. No. 6,172,483, issued Jan. 9, 2001; U.S. Pat. No. 6,172,505, issued Jan. 9, 2001; U.S. Pat. No. 6,222,369, issued Apr. 24, 2001; U.S. Pat. No. 6,225,808, issued May 1, 2001; U.S. Pat. No. 6,249,124, issued Jun. 19, 2001; U.S. Pat. No. 6,259,254, issued Jul. 10, 2001; U.S. Pat. No. 6,262,563, issued Jul. 17, 2001; U.S. Pat. No. 6,294,896, issued Sep. 25, 2001; U.S. Pat. No. 6,294,897, issued Sep. 25, 2001; U.S. Pat. No. 6,304,087, issued Oct. 16, 2001; U.S. Pat. No. 6,310,481, issued Oct. 30, 2001; U.S. Pat. No. 6,313,607, issued Nov. 6, 2001; U.S. Pat. No. 6,313,608, issued Nov. 6, 2001; U.S. Pat. No. 6,316,914, issued Nov. 13, 2001; U.S. Pat. No. 6,323,650, issued Nov. 27, 2001; U.S. Pat. No. 6,329,793, issued Dec. 11, 2001; U.S. Pat. No. 6,331,762, issued Dec. 18, 2001; U.S. Pat. No. 6,332,113, issued Dec. 18, 2001; U.S. Pat. No. 6,351,102, issued Feb. 26, 2002; U.S. Pat. No. 6,359,441, issued Mar. 19, 2002; U.S. Pat. No. 6,363,303, issued Mar. 26, 2002; U.S. Pat. No. 6,377,031, issued Apr. 23, 2002; U.S. Pat. No. 6,392,414, issued May 21, 2002; U.S. Pat. No. 6,417,669, issued Jul. 9, 2002; U.S. Pat. No. 6,424,158, issued Jul. 23, 2002; U.S. Pat. No. 6,441,585, issued Aug. 17, 2002; U.S. Pat. No. 6,437,957, issued Aug. 20, 2002; U.S. Pat. No. 6,445,158, issued Sep. 3, 2002; U.S. Pat. No. 6,456,045; U.S. Pat. No. 6,466,025, issued Oct. 15, 2002; U.S. Pat. No. 6,465,908, issued Oct. 15, 2002; U.S. Pat. No. 6,466,026, issued Oct. 15, 2002; U.S. Pat. No. 6,469,511, issued Nov. 22, 2002; U.S. Pat. No. 6,495,990, issued Dec. 17, 2002; U.S. Pat. No. 6,497,209, issued Dec. 24, 2002; U.S. Pat. No. 6,507,196, issued Jan. 14, 2003; U.S. Pat. No. 6,534,993; issued Mar. 18, 2003; U.S. Pat. No. 6,544,078, issued Apr. 8, 2003; U.S. Pat. No. 6,556,019, issued Apr. 29, 2003; U.S. Pat. No. 6,566,883, issued May 20, 2003; U.S. Pat. No. 6,586,941, issued Jul. 1, 2003; U.S. Pat. No. 6,597,150, issued Jul. 22, 2003; U.S. Pat. No. 6,621,272, issued Sep. 16, 2003; U.S. Pat. No. 6,623,314, issued Sep. 23, 2003; U.S. Pat. No. 6,633,165, issued Oct. 14, 2003; U.S. Pat. No. 6,635,974, issued Oct. 21, 2003; U.S. Pat. No. 6,707,303, issued Mar. 16, 2004; U.S. Pat. No. 6,737,831, issued May 18, 2004; U.S. Pat. No. 6,744,149, issued Jun. 1, 2004; U.S. Pat. No. 6,759,849, issued Jul. 6, 2004; U.S. Pat. No. 6,781,382, issued Aug. 24, 2004; U.S. Pat. No. 6,788,025, filed Sep. 7, 2004; U.S. Pat. No. 6,795,782, issued Sep. 21, 2004; U.S. Pat. No. 6,805,090, filed Oct. 19, 2004; U.S. Pat. No. 6,806,716, filed Oct. 19, 2004; U.S. Pat. No. 6,850,037, filed Feb. 1, 2005; U.S. Pat. No. 6,850,037, issued Feb. 1, 2005; U.S. Pat. No. 6,871,151, issued Mar. 22, 2005; U.S. Pat. No. 6,885,195, issued Apr. 26, 2005; U.S. Pat. No. 6,888,468, issued May 3, 2005; U.S. Pat. No. 6,891,378, issued May 10, 2005; U.S. Pat. No. 6,906,522, issued Jun. 14, 2005; U.S. Pat. No. 6,906,523, issued Jun. 14, 2005; U.S. Pat. No. 6,909,287, issued Jun. 21, 2005; U.S. Pat. No. 6,914,413, issued Jul. 5, 2005; U.S. Pat. No. 6,913,483, issued Jul. 5, 2005; U.S. Pat. No. 6,930,485, issued Aug. 16, 2005; U.S. Pat. No. 6,933,727, issued Aug. 23, 200; U.S. Pat. No. 6,941,234, filed Sep. 6, 2005; U.S. Pat. No. 6,967,484, issued Nov. 22, 2005; U.S. Pat. No. 6,998,847, issued Feb. 14, 2006; U.S. Pat. No. 7,003,410, issued Feb. 21, 2006; U.S. Pat. No. 7,003,411, issued Feb. 21, 2006; U.S. Pat. No. 7,012,433, issued Mar. 14, 2006; U.S. Pat. No. 7,015,674, issued Mar. 21, 2006; U.S. Pat. No. 7,034,541, issued Apr. 25, 2006; U.S. Pat. No. 7,039,533, issued May 2, 2006; U.S. Pat. No. 7,058,525, issued Jun. 6, 2006; U.S. Pat. No. 7,081,755, issued Jul. 25, 2006; U.S. Pat. No. 7,106,070, issued Sep. 12, 2006; U.S. Pat. No. 7,116,109, issued Oct. 3, 2006; U.S. Pat. No. 7,119,686, issued Oct. 10, 2006; and U.S. Pat. No. 7,126,341, issued Oct. 24, 2006; U.S. Pat. No. 7,154,276, issued Dec. 26, 2006; U.S. Pat. No. 7,198,510, issued Apr. 3, 2007; U.S. Pat. No. 7,363,175, issued Apr. 22, 2008; U.S. Pat. No. 7,208,914, issued Apr. 24, 2007; U.S. Pat. No. 7,246,015, issued Jul. 17, 2007; U.S. Pat. No. 7,295,936, issued Nov. 13, 2007; U.S. Pat. No. 7,319,304, issued Jan. 15, 2008; U.S. Pat. No. 7,363,175, issued Apr. 22, 2008; U.S. Pat. No. 7,398,176, issued Jul. 8, 2008; U.S. Pat. No. 7,408,358, issued Aug. 5, 2008; U.S. Pat. No. 7,425,833, issued Sep. 16, 2008; U.S. Pat. No. 7,446,536, issued Nov. 4, 2008; U.S. Pat. No. 7,479,763, issued Jan. 20, 2009; U.S. Pat. No. 7,498,767, issued Mar. 3, 2009; U.S. Pat. No. 7,501,795, issued Mar. 10, 2009; U.S. Pat. No. 7,505,856, issued Mar. 17, 2009; U.S. Pat. No. 7,545,146, issued Jun. 9, 2009; U.S. Pat. No. 7,557,586, issued Jul. 7, 2009; U.S. Pat. No. 7,595,643, issued Sep. 29, 2009; U.S. Pat. No. 7,598,699, issued Oct. 6, 2009; U.S. Pat. No. 7,598,744, issued Oct. 6, 2009; U.S. Pat. No. 7,598,743, issued Oct. 6, 2009; U.S. Pat. No. 7,619,417, issued Nov. 17, 2009; U.S. Pat. No. 7,642,786, issued Jan. 5, 2010; U.S. Pat. No. 7,642,787, issued Jan. 5, 2010; U.S. Pat. No. 7,656,162, issued Feb. 2, 2010; U.S. Ser. No. 09/780,146, filed Feb. 9, 2001, entitled STORAGE BATTERY WITH INTEGRAL BATTERY TESTER; U.S. Ser. No. 09/756,638, filed Jan. 8, 2001, entitled METHOD AND APPARATUS FOR DETERMINING BATTERY PROPERTIES FROM COMPLEX IMPEDANCE/ADMITTANCE; U.S. Ser. No. 09/862,783, filed May 21, 2001, entitled METHOD AND APPARATUS FOR TESTING CELLS AND BATTERIES EMBEDDED IN SERIES/PARALLEL SYSTEMS; U.S. Ser. No. 09/880,473, filed Jun. 13, 2001; entitled BATTERY TEST MODULE; U.S. Ser. No. 10/042,451, filed Jan. 8, 2002, entitled BATTERY CHARGE CONTROL DEVICE; U.S. Ser. No. 10/109,734, filed Mar. 28, 2002, entitled APPARATUS AND METHOD FOR COUNTERACTING SELF DISCHARGE IN A STORAGE BATTERY; U.S. Ser. No. 10/112,998, filed Mar. 29, 2002, entitled BATTERY TESTER WITH BATTERY REPLACEMENT OUTPUT; U.S. Ser. No. 10/263,473, filed Oct. 2, 2002, entitled ELECTRONIC BATTERY TESTER WITH RELATIVE TEST OUTPUT; U.S. Ser. No. 10/310,385, filed Dec. 5, 2002, entitled BATTERY TEST MODULE; U.S. Ser. No. 10/653,342, filed Sep. 2, 2003, entitled ELECTRONIC BATTERY TESTER CONFIGURED TO PREDICT A LOAD TEST RESULT; U.S. Ser. No. 09/653,963, filed Sep. 1, 2000, entitled SYSTEM AND METHOD FOR CONTROLLING POWER GENERATION AND STORAGE; U.S. Ser. No. 10/174,110, filed Jun. 18, 2002, entitled DAYTIME RUNNING LIGHT CONTROL USING AN INTELLIGENT POWER MANAGEMENT SYSTEM; U.S. Ser. No. 10/258,441, filed Apr. 9, 2003, entitled CURRENT MEASURING CIRCUIT SUITED FOR BATTERIES; U.S. Ser. No. 10/681,666, filed Oct. 8, 2003, entitled ELECTRONIC BATTERY TESTER WITH PROBE LIGHT; U.S. Ser. No. 10/791,141, filed Mar. 2, 2004, entitled METHOD AND APPARATUS FOR AUDITING A BATTERY TEST; U.S. Ser. No. 10/867,385, filed Jun. 14, 2004, entitled ENERGY MANAGEMENT SYSTEM FOR AUTOMOTIVE VEHICLE; U.S. Ser. No. 10/958,812, filed Oct. 5, 2004, entitled SCAN TOOL FOR ELECTRONIC BATTERY TESTER; U.S. Ser. No. 60/587,232, filed Dec. 14, 2004, entitled CELLTRON ULTRA, U.S. Ser. No. 11/018,785, filed Dec. 21, 2004, entitled WIRELESS BATTERY MONITOR; U.S. Ser. No. 60/653,537, filed Feb. 16, 2005, entitled CUSTOMER MANAGED WARRANTY CODE; U.S. Ser. No. 60/665,070, filed Mar. 24, 2005, entitled OHMMETER PROTECTION CIRCUIT; U.S. Ser. No. 60,694,199, filed Jun. 27, 2005, entitled GEL BATTERY CONDUCTANCE COMPENSATION; U.S. Ser. No. 11/178,550, filed Jul. 11, 2005, entitled WIRELESS BATTERY TESTER/CHARGER; U.S. Ser. No. 60/705,389, filed Aug. 4, 2005, entitled PORTABLE TOOL THEFT PREVENTION SYSTEM, U.S. Ser. No. 11/207,419, filed Aug. 19, 2005, entitled SYSTEM FOR AUTOMATICALLY GATHERING BATTERY INFORMATION FOR USE DURING BATTERY TESTER/CHARGING, U.S. Ser. No. 60/712,322, filed Aug. 29, 2005, entitled AUTOMOTIVE VEHICLE ELECTRICAL SYSTEM DIAGNOSTIC DEVICE, U.S. Ser. No. 60/713,168, filed Aug. 31, 2005, entitled LOAD TESTER SIMULATION WITH DISCHARGE COMPENSATION, U.S. Ser. No. 60/731,881, filed Oct. 31, 2005, entitled PLUG-IN FEATURES FOR BATTERY TESTERS; U.S. Ser. No. 60/731,887, filed Oct. 31, 2005, entitled AUTOMOTIVE VEHICLE ELECTRICAL SYSTEM DIAGNOSTIC DEVICE; U.S. Ser. No. 11/304,004, filed Dec. 14, 2005, entitled BATTERY TESTER THAT CALCULATES ITS OWN REFERENCE VALUES; U.S. Ser. No. 60/751,853, filed Dec. 20, 2005, entitled BATTERY MONITORING SYSTEM; U.S. Ser. No. 11/304,004, filed Dec. 14, 2005, entitled BATTERY TESTER WITH CALCULATES ITS OWN REFERENCE VALUES; U.S. Ser. No. 60/751,853, filed Dec. 20, 2005, entitled BATTERY MONITORING SYSTEM; U.S. Ser. No. 11/356,443, filed Feb. 16, 2006, entitled ELECTRONIC BATTERY TESTER WITH NETWORK COMMUNICATION; U.S. Ser. No. 11/498,703, filed Aug. 3, 2006, entitled THEFT PREVENTION DEVICE FOR AUTOMOTIVE VEHICLE SERVICE CENTERS; U.S. Ser. No. 11/511,872, filed Aug. 29, 2006, entitled AUTOMOTIVE VEHICLE ELECTRICAL SYSTEM DIAGNOSTIC DEVICE; U.S. Ser. No. 11/519,481, filed Sep. 12, 2006, entitled BROAD-BAND LOW-CONDUCTANCE CABLES FOR MAKING KELVIN CONNECTIONS TO ELECTROCHEMICAL CELLS AND BATTERIES; U.S. Ser. No. 60/847,064, filed Sep. 25, 2006, entitled STATIONARY BATTERY MONITORING ALGORITHMS; U.S. Ser. No. 11/641,594, filed Dec. 19, 2006, entitled METHOD AND APPARATUS FOR MEASURING A PARAMETER OF A VEHICLE ELECTRONIC SYSTEM; U.S. Ser. No. 11/711,356, filed Feb. 27, 2007, entitled BATTERY TESTER WITH PROMOTION FEATURE; U.S. Ser. No. 11/811,528, filed Jun. 11, 2007, entitled ALTERNATOR TESTER; U.S. Ser. No. 60/950,182, filed Jul. 17, 2007, entitled BATTERY TESTER FOR HYBRID VEHICLE; U.S. Ser. No. 60/973,879, filed Sep. 20, 2007, entitled ELECTRONIC BATTERY TESTER FOR TESTING STATIONARY BATTERIES; U.S. Ser. No. 11/931,907, filed Oct. 31, 2007, entitled BATTERY MAINTENANCE WITH PROBE LIGHT; U.S. Ser. No. 60/992,798, filed Dec. 6, 2007, entitled STORAGE BATTERY AND BATTERY TESTER; U.S. Ser. No. 12/099,826, filed Apr. 9, 2008, entitled BATTERY RUN DOWN INDICATOR; U.S. Ser. No. 61/061,848, filed Jun. 16, 2008, entitled KELVIN CLAMP FOR ELECTRONICALLY COUPLING TO A BATTERY CONTACT; U.S. Ser. No. 12/168,264, filed Jul. 7, 2008, entitled BATTERY TESTERS WITH SECONDARY FUNCTIONALITY; U.S. Ser. No. 12/174,894, filed Jul. 17, 2008, entitled BATTERY TESTER FOR ELECTRIC VEHICLE; U.S. Ser. No. 12/204,141, filed Sep. 4, 2008, entitled ELECTRONIC BATTERY TESTER OR CHARGER WITH DATABUS CONNECTION; U.S. Ser. No. 12/328,022, filed Dec. 4, 2008, entitled STORAGE BATTERY AND BATTERY TESTER; U.S. Ser. No. 12/416,457, filed Apr. 1, 2009, entitled SYSTEM FOR AUTOMATICALLY GATHERING BATTERY INFORMATION; U.S. Ser. No. 12/416,453, filed Apr. 1, 2009, entitled INTEGRATED TAG READER AND ENVIRONMENT SENSOR; U.S. Ser. No. 12/416,445, filed Apr. 1, 2009, entitled SIMPLIFICATION OF INVENTORY MANAGEMENT; U.S. Ser. No. 12/485,459, filed Jun. 16, 2009, entitled CLAMP FOR ELECTRONICALLY COUPLING TO A BATTEYR CONTACT; U.S. Ser. No. 12/498,642, filed Jul. 7, 2009, entitled ELECTRONIC BATTERY TESTER; U.S. Ser. No. 12/697,485, filed Feb. 1, 2010, entitled ELECTRONIC BATTERY TESTER; U.S. Ser. No. 12/698,375, filed Feb. 2, 2010, entitled ELECTRONIC BATTERY TESTER; U.S. Ser. No. 12/712,456, filed Feb. 25, 2010, entitled METHOD AND APPARATU FOR DETECTING CELL DETERIORATION IN AN ELECTROCHEMICAL CELL OR BATTEYR; U.S. Ser. No. 61/311,485, filed Mar. 8, 2010, entitled BATTERY TESTER WITH DATABUS FOR COMMUNICATING WITH VEHICLE ELECTRICAL SYSTEM U.S. Ser. No. 61/313,893, filed Mar. 15, 2010, entitled USE OF BATTERY MANUFACTURE/SELL DATE IN DIAGNOSIS AND RECOVERY OF DISCHARGED BATTERIES; which are incorporated herein in their entirety.

### SUMMARY OF THE INVENTION

An electronic battery tester for testing a storage battery including electrical connectors configured to couple to the storage battery. Measurement circuitry is coupled to the electrical connectors and a display is configured to display information to an operator. A manual input is configured to receive an input from a user. A microprocessor is coupled to the measurement circuitry and is configured to perform a battery test on the storage battery as a function of a battery parameter measured with the measurement circuitry. The microprocessor is configured to display characters and receive a character select input from the manual input which identifies one character of a plurality of characters displayed on the display. In another aspect, a forcing function is coupled to the battery and has first and second selectable frequencies. The microprocessor is configured to select between the first frequency and the second frequency.

### BRIEF DESCRIPTION OF THE DRAWINGS

FIG. 1 is a simplified diagram of electronic battery tester in accordance with the present invention.

FIG. 2 is a front plan view of the electronic battery tester shown in FIG. 1.

### DETAILED DESCRIPTION OF ILLUSTRATIVE EMBODIMENTS

The present invention relates to electronic battery testers. More specifically, the present invention relates to electronic battery testers used to test storage batteries.

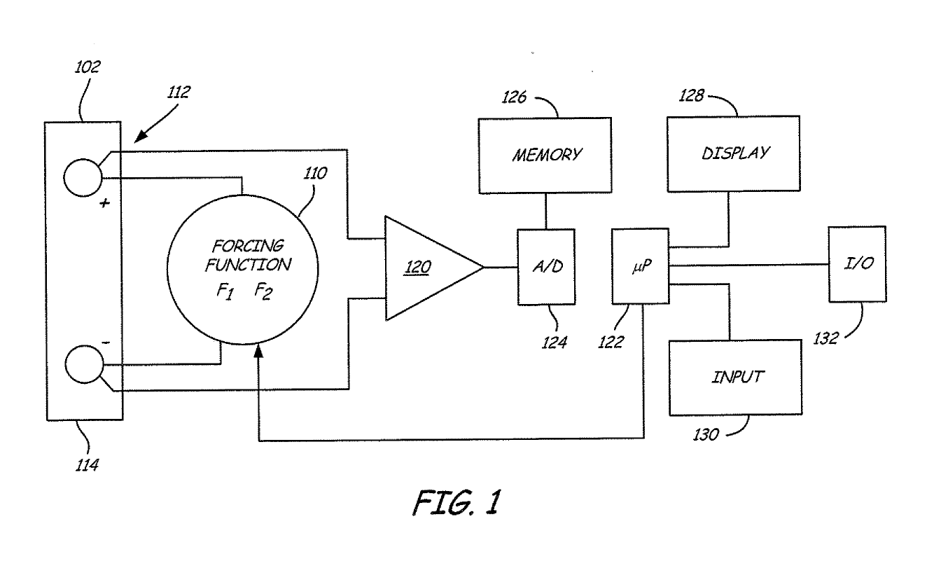

FIG. 1 is a simplified diagram of an electronic battery tester 100 configured for testing a storage battery 102. Battery tester 100 configured for testing a storage battery 102. Battery tester 100 includes a forcing function 110 electrically coupled to battery 102 through Kelvin connectors 112 and 114 which couple to the positive and negative terminals, respectively, battery 102. An amplifier 120 also couples to the positive and negative terminals of battery 102 through Kelvin connections 112 and 114. The output from the amplifier 120 is provided to a microprocessor 122 through an analog to digital converter 124. Microprocessor 122 operates in accordance with programming instructions stored in memory 126 and is configured to provide an output to an operator to display 128. Further, an input 130 can be used to provide an input to microprocessor 122 from the operator. Optional I/O circuitry 132 is also illustrated and can comprise, for example, a data connection to a remote location.

Forcing function source 110 causes a forcing function to be applied to a storage battery 102. Forcing function source 110 can be an active source or a passive source. An active source is a source in which a signal is actively generated and applied to the battery 102. A passive source is one in which, for example, a load is applied to the battery 102 to generate the forcing function signal. The forcing function signal cam include a time varying component, for example, an AC signal. The response of battery 102 to the forcing function can be measured using amplifier 120 and monitored by the microprocessor 122 in which a signal is caused to pass through analog to digital converter 134. This can be used to determine a dynamic parameter of battery 102 in accordance with techniques described in the Background section. For example, the dynamic parameter can be related to dynamic conductance of the battery 102 and correlated to the cold cranking amps or amp hours of battery 102. The microprocessor 122 operates in accordance with instructions stored in memory 126 and can provide an output to an operator using display 128 which indicates a result of battery test, for example, a condition of the battery 102.

In accordance with one aspect of the present invention, the forcing function source 100 is configured to provide a forcing function at more than one frequency. For example, the forcing function source 110 can provide a first forcing function having a frequency of F₁ and a second forcing function of F₂. An operator can select the desired forcing function frequency using input 130.

A forcing function signal having a frequency F₁ may be useful for measuring stationary battery, such as large standby batteries. Similarly, a forcing function signal having a different frequency F₂ may be used to perform a battery test on a storage battery of the type used in an automotive vehicle. In one specific example, a forcing function signal with a frequency of 22 Hz is used for performing a battery test on a stationary or standby battery and a forcing function signal having a frequency of 88 Hz is used for performing a battery test on a starter battery such as a vehicle battery. In another example, 100 Hz is use for performing a battery test on a starter battery such as a vehicle battery. Although only two forcing functions signal frequencies are illustrated, any number of frequencies may be employed. Further the forcing function source 110 may generate a forcing function signal at discreet frequencies or having a continuous frequency range. In general, in this aspect, the present invention provides a forcing function source which provides a forcing function signal having a selectable frequency, where the frequency of the forcing function is selected based upon a type of storage battery under test. The selection can be manual, for example, using input 130 or can be performed automatically. For example, an automatic system can be configured to select a desired forcing function signal frequency based upon a voltage of the battery 102 or some other information.

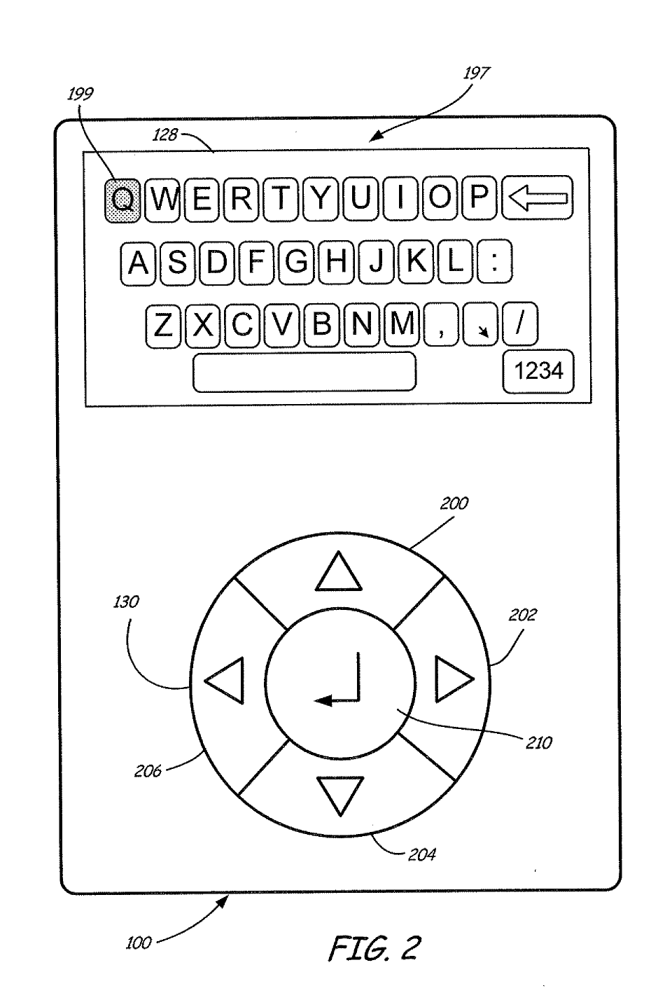

FIG. 2 is a diagram of a front plan view of battery tester 100 illustrating another aspect of the present invention. In FIG. 2, battery tester 100 shows display 128 and input 130. Display 128 can be any type of display capable of displaying information such as an LCD display, LED display, or other technology. In FIG. 2, display 128 is illustrated as showing a “virtual keyboard” 197 in which the alphabet is illustrated including a number of punctuations, a space bar, a backspace and a select button which allows the selection of a numerical keyboard. In FIG. 2, one of the keys, the “Q” key, is highlighted. This illustrates a position of a cursor 199 which can be moved between the various keys shown on display 128. Manual input 130 includes four movement buttons. These movement buttons are an up button 200, a right button 202, a down button 204 and a left button 206. Movement buttons 200, 202, 204 and 206 can be used to move the cursor 199 on virtual keyboard 197. After the cursor 199 is positioned to highlight a desired key, an enter button 210 can be pressed by the operator in order to select that particular key for entry.

In another example configuration, display 128 comprises a touch screen display. In this configuration, the display 128 is sensitive to a touch from the operator and is capable of identifying a location on the display of where that touch occurs. This identified location is provided to microprocessor 122 such that the selected key is identified. In such a configuration, the display operates as both display 128 and as an input 130.

The configuration of display 128 and virtual keyboard 197 shown in FIG. 2 allows alphanumeric characters to be entered in the battery tester 100 without implementing a complete push button style keyboard. In operation, the microprocessor 122 is configured to prompt an operator for information using display 128. The operator then uses the virtual keyboard 197 to input the information. Examples of such information include location ID, site name or number, system ID (name or number), string ID (name or number), technician ID (name or number).

The information input by the operator through input 130 can then be stored in memory 126 for subsequent use by microprocessor 122.

Although the present invention has been described with reference to preferred embodiments, workers skilled in the art will recognize that changes may be made in form and detail without departing from the spirit and scope of the invention.

What is claimed is:

1. An electronic battery tester for testing a storage battery, comprising:
electrical connectors configured to couple to the storage battery;
measurement circuitry coupled to the electrical connectors;
a display configured to display information to an operator;
a manual input configured to receive an input from a user; and
a microprocessor coupled to the measurement circuitry configured to perform a battery test on the storage battery as a function of a battery parameter measured with the measurement circuitry, the microprocessor configured to display a plurality of characters on the display and receive a character select input from the manual input which identifies one character of a plurality of characters displayed on the display.

2. The electronic battery tester of claim 1 wherein the microprocessor is further configured to display a cursor on the display.

3. The electronic battery tester of claim 2 wherein the manual input is configured to provide an input to the microprocessor related to a desired position of the cursor on the display.

4. The electronic battery tester of claim 3 wherein the manual input comprises four movement buttons.

5. The electronic battery tester of claim 3 wherein the manual input includes an enter button.

6. The electronic battery tester of claim 1 wherein the characters comprise alphabetic characters.

7. The electronic battery tester of claim 1 wherein the characters comprise numeric characters.

8. The electronic battery tester of claim 1 wherein the display comprises a touch screen display and manual input comprises a touch input of the touch screen display.

9. The electronic battery tester of claim 1 including a forcing function source configured to apply a forcing function signal to the battery, the forcing function signal having first and second selectable frequencies.

10. The electronic battery tester of claim 9 wherein the microprocessor is configured to select the first frequency if the storage battery comprises a standby battery and to select the second frequency if the storage battery comprises a vehicle battery.

11. An electronic battery tester for testing a storage battery, comprising:
Kelvin connectors configured to electrically couple to terminals of a storage battery;
a forcing function source configured to apply a forcing function signal to the battery through the Kelvin connectors, the forcing function signal having first and second selectable frequencies;
measurement circuitry configured to measure a parameter of the battery generated in response to the forcing function signal; and
a microprocessor configured to perform a battery test based upon the parameter of the battery, the microprocessor further configured to select the first frequency if the storage battery comprises a standby battery and select the second frequency if the storage battery comprises a vehicle battery.

12. The electronic battery tester of claim 11 including a display and wherein the microprocessor is further configured to display a cursor and characters on the display.

13. The electronic battery tester of claim 12 including a manual input configured to provide an input to the microprocessor related to a desired position of the cursor on the display.

14. The electronic battery tester of claim 13 wherein the manual input comprises four movement buttons.

15. The electronic battery tester of claim 13 wherein the manual input includes an enter button.

16. The electronic battery tester of claim 12 wherein the display comprises a touch screen display.

17. The electronic battery tester of claim 11 including a manual input configured to select between the first and second frequencies.

18. The electronic battery tester of claim 11 wherein the microprocessor is configured to automatically select between the first and second frequencies.

19. The electronic battery tester of claim 18 wherein the automatic selection is based upon a battery voltage of the storage battery.

20. The electronic battery tester of claim 11 wherein the first frequency comprises 22 Hz.

21. The electronic battery tester of claim 11 wherein the second frequency comprises 88 Hz.

22. The electronic battery tester of claim 11 wherein the forcing function comprises an active forcing function.

23. The electronic battery tester of claim 11 wherein the forcing function comprises a passive forcing function.

24. The electronic battery tester of claim 11 wherein the second frequency comprises 100 Hz.
